(19) United States
(12) Patent Application Publication
(10) Pub. No.: US 2011/0276156 A1
(43) Pub. Date: Nov. 10, 2011

(54) 4D Vehicle Entertainment System

(75) Inventors: Tara Thweny, Commerce Twp, MI (US); Bill Johnson, Royal Oak, MI (US); Robert Gee, Lake Barrington, IL (US); Shafer Seymour, Bartlett, IL (US)

(73) Assignee: CONTINENTAL AUTOMOTIVE SYSTEMS, INC., Deer Park, IL (US)

(21) Appl. No.: 12/776,815

(22) Filed: May 10, 2010

(51) Int. Cl. G06F 17/00

(52) U.S. Cl. 700/94

(57) ABSTRACT

Methods and systems for analyzing communication options, including providing one or more 4D entertainment signals, the one or more entertainment signals being associated with one or more 4D entertainment effects, providing one or more vehicle systems; and interfacing the one or more signals with the one or more vehicle systems, the one or more vehicle systems being configured to implement the one or more 4D entertainment effects.

### I. BACKGROUND

The invention relates generally to the field of interfacing 4D entertainment sources with vehicle systems.

### II. SUMMARY

In one respect, disclosed is a method for providing one or more 4D entertainment signals, the one or more entertainment signals being associated with one or more 4D entertainment effects; providing one or more vehicle systems; and interfacing the one or more signals with the one or more vehicle systems, the one or more vehicle systems being configured to implement the one or more 4D entertainment effects.

In another respect, disclosed is a system for interfacing 4D entertainment sources with vehicle 4D effect systems, the system including: one or more processors; one or more memory units coupled to the one or more processors; the system being configured to: be provided with one or more 4D entertainment signals, the one or more entertainment signals being associated with one or more 4D entertainment effects; be provided with one or more vehicle systems; and interface the one or more signals with the one or more vehicle systems, the one or more vehicle systems being configured to implement the one or more 4D entertainment effects.

In yet another respect, disclosed is a computer program product stored on a computer operable medium, the computer program product comprising software code being effective to: be provided with one or more 4D entertainment signals, the one or more entertainment signals being associated with one or more 4D entertainment effects; be provided with one or more vehicle systems; and determine an interface of the one or more signals with the one or more vehicle systems, the one or more vehicle systems being configured to implement the one or more 4D entertainment effects.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1 is a block diagram illustrating a system for interfacing 4D entertainment sources with vehicle systems, in accordance with some embodiments.

FIG. 2 is a block diagram illustrating an alternative system for interfacing 4D entertainment sources with vehicle systems, in accordance with some embodiments.

FIG. 3 is a block diagram illustrating a system for interfacing 4D entertainment sources with vehicle systems as the system may be used in an automobile, in accordance with some embodiments.

FIG. 4 is a flow diagram illustrating a method for interfacing 4D entertainment sources with existing vehicle systems, in accordance with some embodiments.

FIG. 5 is a flow diagram illustrating a method for interfacing 4D entertainment sources with existing vehicle systems with a user-customizable interface, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Disclosed is a method for interfacing 4D entertainment sources with vehicle 4D effect systems, including: providing one or more 4D entertainment signals, the one or more entertainment signals being associated with one or more 4D entertainment effects; providing one or more vehicle 4D effect systems; and interfacing the one or more signals with the one or more vehicle 4D effect systems, the one or more vehicle 4D effect systems being configured to implement one or more of the 4D entertainment effects

In some embodiments, systems and methods are disclosed for interfacing 4D entertainment sources with existing vehicle systems (or vehicle 4D effect systems). One or more 4D entertainment signals are associated with one or more 4D entertainment effects and the one or more 4D entertainment signals may be interfaced with the one or more vehicle systems configured to implement one or more of the 4D entertainment effects. The vehicle systems may include existing as well as custom systems. 4D entertainment effects may include: vibration, wind, changes in temperature, changes in lighting, smells, mist, bubbles, etc. Vehicle 4D effect systems may include seat vibration units, seatbelt tensioners, HVAC system, internal lights, etc. In some embodiments, vehicle systems may be any system in a vehicle that can be used to implement one or more of the 4D entertainment effects.

In some embodiments, vehicle 4D effect systems may include systems installed in the vehicle for the explicit purpose of implementing one or more 4D entertainment effects. Examples include: vibration units (rumble packs) installed to deliver vibrations to passenger's seats; lights installed to provide colored lighting, flashing lights, bursts of light, etc.; scent units installed to deliver scents; mist/bubble units installed to deliver sprays of mist or bubbles; visual displays installed to provide 2D or 3D images; audio speakers installed to provide sound effects; etc.

In some embodiments, vehicle 4D effect systems may include existing vehicle systems that can also be used to deliver 4D effects in addition to being used for the systems' existing purposes. For example, seat belt tensioners may be used to provide vibration or tension effects; interior vehicle lights may be used to provide lighting effects; the HVAC system may be used to modulate vehicle temperature (e.g. increase cabin temperature if film characters enter a very hot area) or send a blast of air over passengers to replicate wind in the film, etc.; seat heaters may be activated to provide extra heating effects; windows with variable tint ability may change tint during the daytime to change vehicle lighting; tinted windows may be lowered during bright sunlight to provide a flash of light; power windows may be opened to provide a blast of air, increase cabin noise or provide a sudden change in cabin temperature; etc.

In some embodiments, internal and external sensors may be used to measure internal and external environmental conditions such as temperature, light levels, and precipitation. The information from these sensors may be used by the 4D interface system to determine appropriate methods of implementing the 4D effects. For example, if a passenger is watching a 4D movie with people approaching a fire, there may be a 4D effect requiring a blast of hot air. In some configurations, this effect may be accomplished by opening the vehicle windows to let in outside air if the outside temperature is above some threshold temperature and hotter than the internal vehicle temperature. However, outside air may not be used when hot air is required and the outside temperature is below the threshold. Similarly, the system may be configured not to open the windows when wind is required if it is raining outside, and not to open the windows when light is needed and it is dark outside.

In some embodiments, the mapping and configuration of 4D signals may be customized by the users. The controls may be centralized or in some embodiments, the controls may be available at each passenger seat and/or vehicle system. Users may select which seats will have 4D effects activated, which effects to activate, customized effects mapping, modulation of the effects, etc. In some embodiments, users may also map 4D signals to multiple vehicle 4D effects systems. For example, in a minivan with five rear seats, each of the users may select to have 4D effects activated for their seats, they may choose to activate either a seat vibration unit and/or use seatbelt tensioners to transmit vibration effects and they can choose the intensity of these effects. These adjustments can be made before playing the 4D movie/video or at any time during the movie/video.

The mapping of 4D signals may be preconfigured/customized for each type of vehicle. The system may also be preconfigured with additional preset settings that the user may select though the user interface. In addition, the user interface may allow the user to customize the settings both in terms of mapping and in terms of intensity.

In some embodiments, the driver and front passenger may be isolated from the 4D effects in order to prevent them from being distracted or disturbed by the 4D effects. This may be accomplished using a physical barrier such as a glass partition, for example. In other embodiments, the isolation may be accomplished by using active noise/vibration cancellation techniques. For example, sound and/or vibration generators may be configured to generate cancelling sounds and/or vibrations to minimize the sounds and/or vibrations reaching the driver and front passenger.

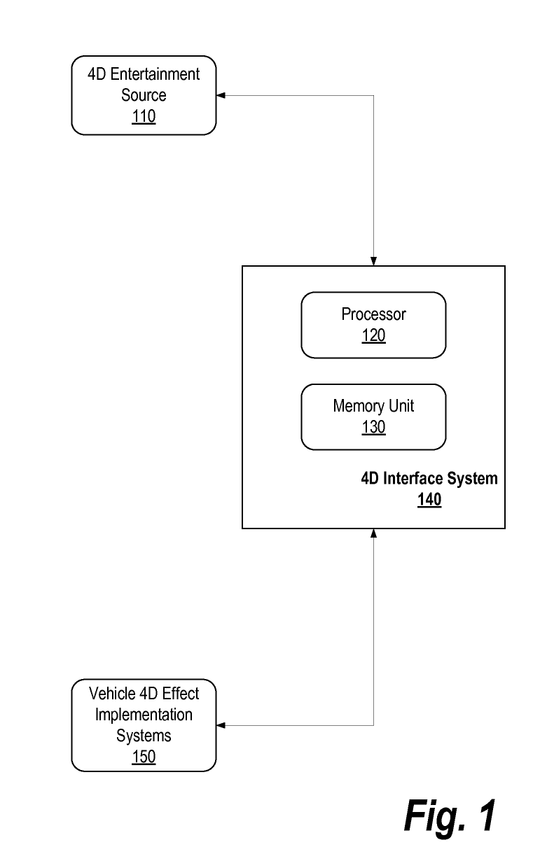

FIG. 1 is a block diagram illustrating a system for interfacing 4D entertainment sources with vehicle systems, in accordance with some embodiments.

In some embodiments, 4D interface system 140 is configured to receive 4D entertainment signals from 4D entertainment source 110 and then distribute those signals to the appropriate vehicle 4D effect implementation systems 150. 4D interface system 140 may be configured intelligently translate the 4D entertainment signals, and/or intelligently map the 4D entertainment signals to the vehicle systems, and/or intelligently modulate the intensity of the effects.

In some embodiments, 4D interface system 140 may comprise one or more processors 120 and one or more memory units 130, which are coupled to one or more processors 120. Processors 120 and memory units 130 may be configured to perform the functionality of 4D interface system 140. In other embodiments, other combinations of hardware units and/or software code may be used to implement 4D interface system 140.

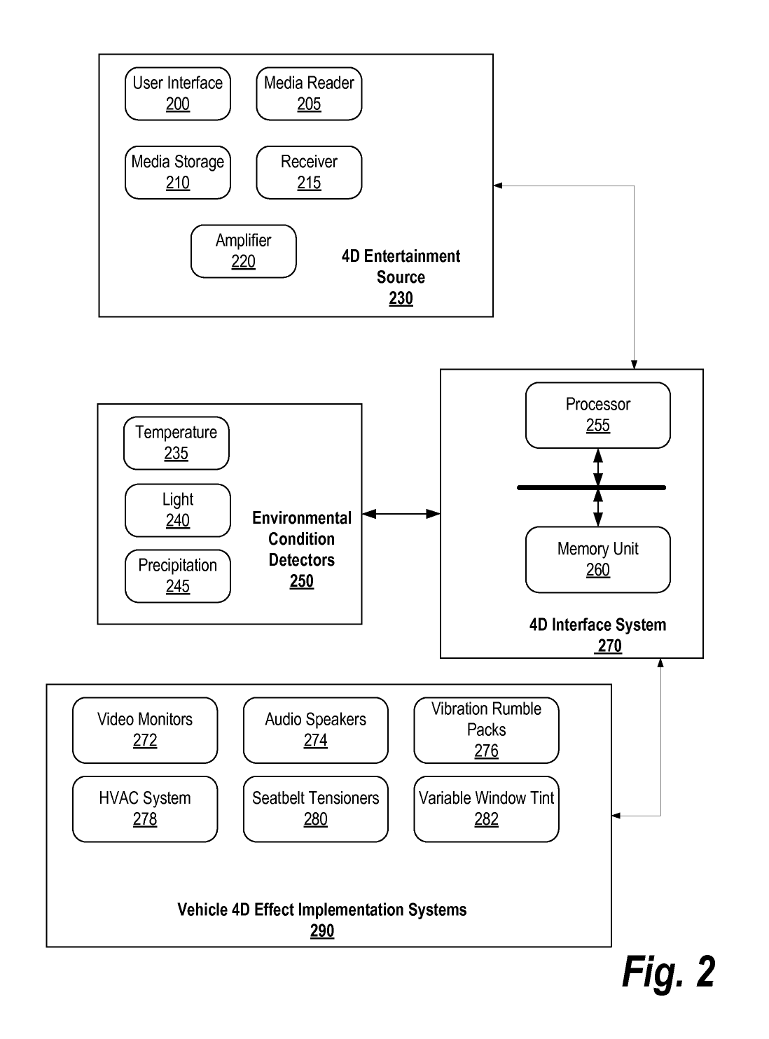

FIG. 2 is a block diagram illustrating an alternative system for interfacing 4D entertainment sources with vehicle systems, in accordance with some embodiments.

In some embodiments, 4D interface system 270 is configured to receive 4D entertainment signals from 4D entertainment source 230 and environmental condition data from environmental condition detectors 250. Based on the environmental condition data, the 4D entertainment signals received from 4D entertainment source 230, and user preferences as defined by user interface 200, 4D interface system 270 determines how to implement the 4D effects and sends the appropriate commands to vehicle 4D effect implementation systems 290.

In some embodiments, 4D entertainment source 230 may comprise user interface 200, media reader 205, media storage 210, receiver 215, and amplifier 220. User interface 200 may be configured to allow users to input their 4D effects preferences, selecting which seats in the vehicle receive 4D effects, and the mapping and modulation of 4D effect signals to 4D effect implementation systems. In some embodiments, user interface 200 may comprise a central control unit as well as auxiliary control units distributed throughout the vehicle, such as control units at each seat, for example.

In some embodiments, 4D interface system 270 may comprise one or more processors 255 and one or more memory units 260, which are coupled to one or more processors 255. Processors 255 and memory units 260 may be configured to perform the functionality of 4D interface system 270. In other embodiments, other combinations of hardware units and/or software code may be used to implement 4D interface system 270.

In some embodiments, environmental conditions detectors 250 may comprise internal and external detectors such as temperature detector 235, light detector 240, and precipitation detector 245. In some embodiments, the choice of vehicle 4D effect implementation systems may be dependent on environmental conditions. For example, in a vehicle with tinted windows, a scene of the movie may call for a bright flash of light as a 4D effect. This effect could be implemented by either opening the windows or varying the tint of the windows. However, if it is dark outside and/or extremely cold, the 4D interface system 270 may choose to implement the effect in another manner.

In some embodiments, vehicle 4D effect implementation systems 290 may comprise both dedicated entertainment systems such as video monitors 272, audio speakers 274, and vibration rumble packs 276 as well as vehicle systems that in addition to their primary functions are capable of providing 4D effects such as HVAC system 278, seatbelt tensioners 280, variable window tint 282.

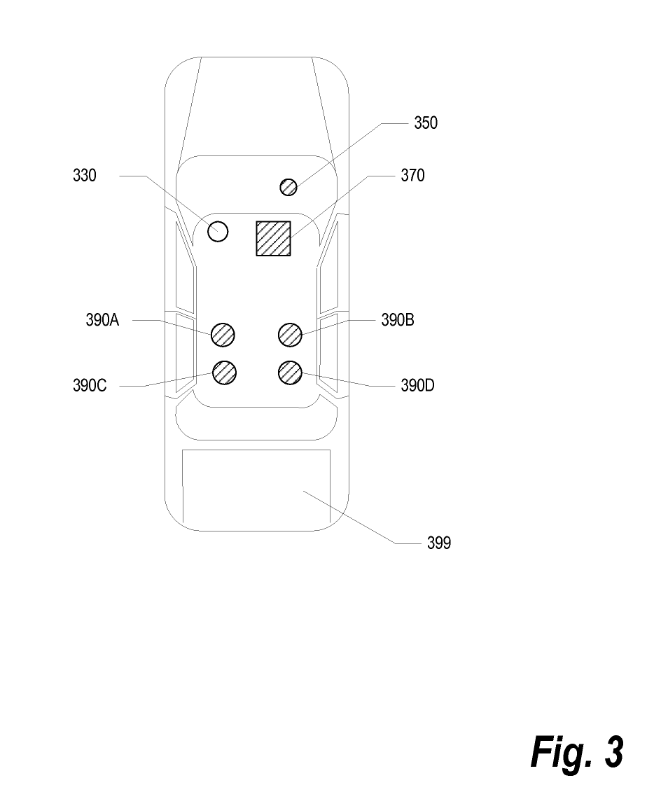

FIG. 3 is a block diagram illustrating a system for interfacing 4D entertainment sources with vehicle systems as the system may be used in an automobile, in accordance with some embodiments.

In some embodiments, vehicle 399 comprises 4D interface system 370, which is configured to receive 4D entertainment signals from 4D entertainment source 330 and environmental condition data from environmental condition detectors 350. Based on the environmental condition data received by environmental detectors 350, the 4D entertainment signals received from 4D entertainment source 330, and user preferences as defined by user interface 300, 4D interface system 370 determines how to implement the 4D effects and sends the appropriate commands to vehicle 4D effect implementation systems 390A-D. In some embodiments, 4D effect implementation systems 390A-D may be proximate to one or more of the seats of vehicle 399.

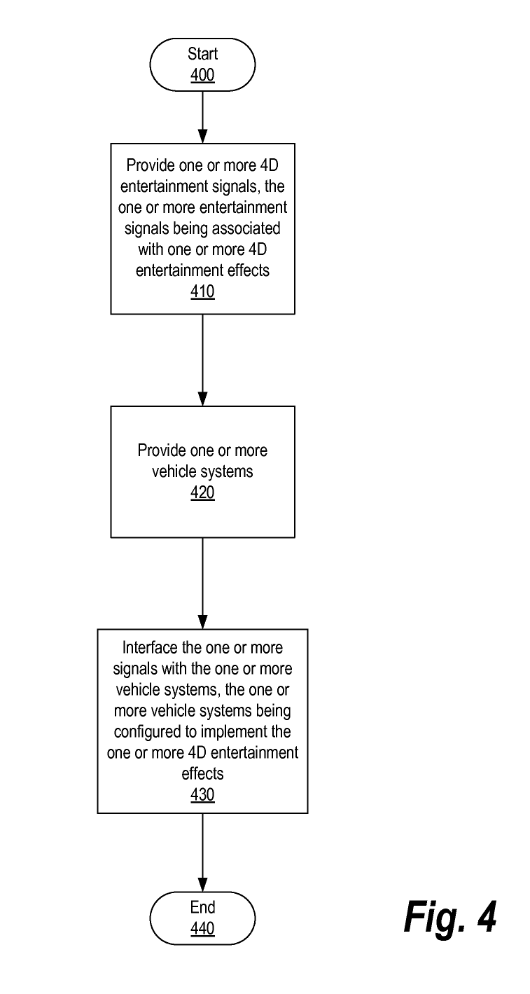

FIG. 4 is a flow diagram illustrating a method for interfacing 4D entertainment sources with existing vehicle systems, in accordance with some embodiments.

In some embodiments, the method illustrated in FIG. 4 may be performed by one or more of the devices illustrated in FIG. 1, FIG. 2, and FIG. 3.

Processing begins at 400 whereupon, at block 410, one or more 4D entertainment signals are provided, the one or more entertainment signals being associated with one or more 4D entertainment effects.

At block 420, one or more vehicle systems are provided.

Next, at block 430, the one or more signals are interfaced with the one or more vehicle systems, the one or more vehicle systems being configured to implement the one or more 4D entertainment effects.

Processing subsequently ends at 440.

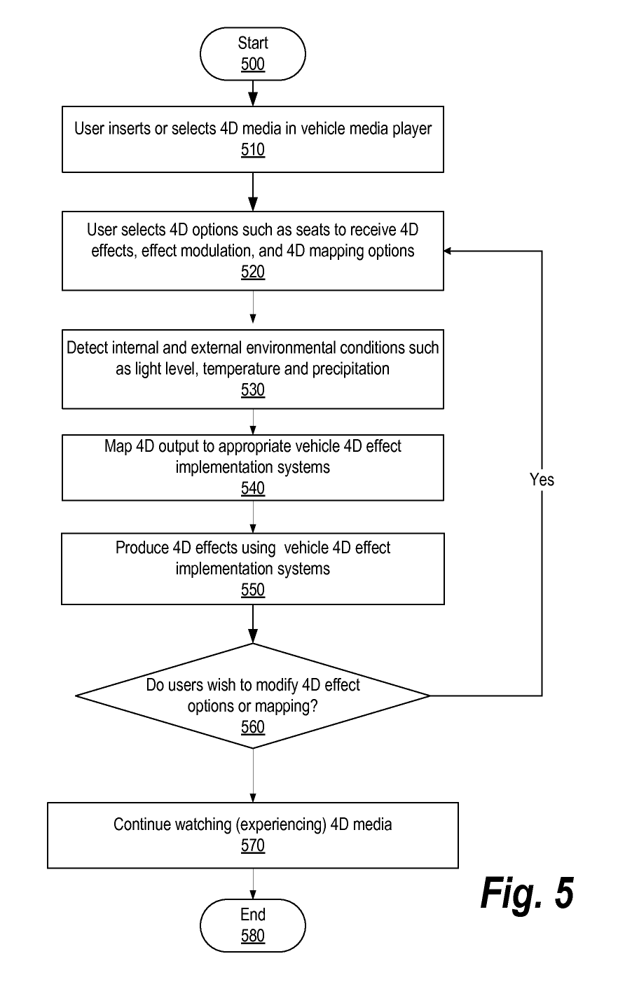

FIG. 5 is a flow diagram illustrating a method for interfacing 4D entertainment sources with existing vehicle systems with a user-customizable interface, in accordance with some embodiments.

In some embodiments, the method illustrated in FIG. 5 may be performed by one or more of the devices illustrated in FIG. 1, FIG. 2, and FIG. 3. Processing begins at 500 whereupon, at block 510, a user inserts or selects 4D media in the vehicle media player. At block 520, the user can select 4D entertainment options, such as the seats to receive 4D effects, effect modulation, and 4D signal mapping options. For example, in a movie with vibration effects, some users may wish to have vibrations transmitted using seat vibration rumble packs, whereas some users may prefer to have vibration effects transmitted via the seatbelt tensioners. Some users may elect to have vibrations transmitted using both seat vibration rumble packs and seatbelt tensioners, while some users may opt to omit vibration effects entirely.

Subsequently, at block 530, internal and external environmental conditions such as light level, temperature and precipitation are detected. These conditions may influence the selection and/or modulation of vehicle 4D effect implementation systems. At block 540, the 4D effects output is mapped to the appropriate vehicle 4D effect implementation systems according to user selections, 4D media specifications, and environmental conditions. For example, a 4D movie may call for warm temperatures to reflect that characters are entering a burning house. If users selected that two out of the three seats in the back of the vehicle receive 4D effects, signals are transmitted only to those two seats. Furthermore, if it is very hot outside the vehicle, the 4D interface system may decide to provide a blast of heat by momentarily opening the vehicle windows. Next at block 550, the 4D effects are produced using the vehicle 4D effect implementation systems.

At any point during the playing of the 4D media, users may modify 4D effect options or mapping at decision 560. If users wish to modify 4D effect options, decision 560 branches to the “yes” branch, whereupon processing continues at block 520. If users are satisfied with the current 4D effect options, decision 560 branches to the “no” branch, whereupon processing continues at block 570 and users continue to experience the 4D media.

Processing subsequently ends at 580.

Those of skill will appreciate that the various illustrative logical blocks, modules, circuits, and algorithm steps described in connection with the embodiments disclosed herein may be implemented as electronic hardware, computer software, or combinations of both. To illustrate clearly this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for interfacing a 4D entertainment system with vehicle systems, the method comprising:
providing one or more 4D entertainment signals, the one or more entertainment signals being associated with one or more 4D entertainment effects;
providing one or more vehicle systems; and
interfacing the one or more signals with the one or more vehicle systems, the one or more vehicle systems being configured to implement the one or more 4D entertainment effects.

2. The method of claim 1, further comprising intelligently mapping the one or more of the 4D entertainment signals to the one or more vehicle systems.

3. The method of claim 1, further comprising translating the one or more 4D entertainment signals to one or more vehicle systems communication protocols, the one or more vehicle systems communication protocols corresponding to the one or more vehicle systems.

4. The method of claim 1, further comprising providing a user interface, the user interface being configured to allow a user to customize a selective mapping of the 4D entertainment signals to the one or more vehicle systems.

5. The method of claim 1, further comprising providing a user interface, the user interface being configured to customize the intensities of the one or more 4D entertainment effects.

6. A system for interfacing a 4D entertainment system with vehicle systems, the system comprising:
one or more processors;
one or more memory units coupled to the one or more processors;
the system being configured to:
be provided with one or more 4D entertainment signals, the one or more entertainment signals being associated with one or more 4D entertainment effects;
be provided with one or more vehicle systems; and
interface the one or more signals with the one or more vehicle systems, the one or more vehicle systems being configured to implement the one or more 4D entertainment effects.

7. The system of claim 6, being further configured to intelligently map the one or more of the 4D entertainment signals to the one or more vehicle systems.

8. The system of claim 6, being further configured to translate the one or more 4D entertainment signals to one or more vehicle systems communication protocols, the one or more vehicle systems communication protocols corresponding to the one or more vehicle systems.

9. The system of claim 6, being further configured to provide a user interface, the user interface being configured to allow a user to customize a selective mapping of the 4D entertainment signals to the one or more vehicle systems.

10. The system of claim 6, being further configured to provide a user interface, the user interface being configured to customize the intensities of the one or more 4D entertainment effects.

11. The system of claim 6, further comprising a vehicle, the vehicle comprising the system for interfacing a 4D entertainment system with vehicle systems.

12. A computer program product stored on a computer operable medium, the computer program product comprising software code being effective to interface a 4D entertainment system with vehicle systems by being effective to:
be provided with one or more 4D entertainment signals, the one or more entertainment signals being associated with one or more 4D entertainment effects;
be provided with one or more vehicle systems; and
determine an interface of the one or more signals with the one or more vehicle systems, the one or more vehicle systems being configured to implement the one or more 4D entertainment effects.

13. The product of claim 12, being further effective to intelligently map the one or more of the 4D entertainment signals to the one or more vehicle systems.

14. The product of claim 12, being further effective to translate the one or more 4D entertainment signals to one or more vehicle systems communication protocols, the one or more vehicle systems communication protocols corresponding to the one or more vehicle systems.

15. The product of claim 12, being further effective to provide a user interface, the user interface being configured to allow a user to customize a selective mapping of the 4D entertainment signals to the one or more vehicle systems.

16. The product of claim 12, being further effective to provide a user interface, the user interface being configured to customize the intensities of the one or more 4D entertainment effects.

17. The product of claim 12, further comprising a vehicle, the vehicle comprising the product for interfacing a 4D entertainment system with vehicle systems.
